(19) United States
(12) Patent Application Publication
(10) Pub. No.: US 2016/0012693 A1
(43) Pub. Date: Jan. 14, 2016

(54) Tamper Detection in AC-Powered Tags

(71) Applicant: Emanate Wireless, Inc., Ijamsville, MD (US)

(72) Inventor: Gary L. Sugar, Rolling Meadows, IL (US)

(21) Appl. No.: 14/791,717

(22) Filed: Jul. 6, 2015

Related U.S. Application Data
(60) Provisional application No. 62/023,404, filed on Jul. 11, 2014.
(60) Provisional application No. 62/033,229, filed on Aug. 5, 2014.

(51) Int. Cl. G08B 13/14

(52) U.S. Cl. CPC G08B 13/1418

(57) ABSTRACT

A pass-through tag detects whether it remains attached to a host device and/or the power supply for the host device. The pass-through tag sends a test signal toward the host device and monitors for a response signal indicating that the pass-through tag is coupled to the host device. The test signal may be applied along the power conductors or along isolated conductors dedicated to the tamper detection system. If the response signal, or the lack of a response signal after a pre-determined amount of time, indicates that the pass-through tag has been unplugged from the host device, then the pass-through tag can alert a central server through an RF transceiver in the tag.

### CROSS-REFERENCE TO RELATED APPLICATIONS

This application claims the benefit of U.S. Provisional Patent Application No. 62/023,404, “Tamper Detection System for an AC-Powered RTLS/RFID Tag”, filed Jul. 11, 2014 which is incorporated by reference herein in its entirety. This application further claims the benefit of U.S. Provisional Patent Application No. 62/033,229, “Tamper Detection System and Method For an AC-Powered RTLS/RFID Tag”, filed Aug. 5, 2014 which is incorporated by reference herein in its entirety.

### FIELD OF THE INVENTION

The present disclosure relates to monitoring an electrically powered host device through an integrated electrical pass-through connection between an electrical power source and the host device.

### BACKGROUND OF THE INVENTION

In hospital settings, pass-through tags can be placed between the input electrical power connector on a host device (e.g., an infusion pump, ventilator, etc.) and an electrical power cable for the host device. This placement of the pass-through tag can automatically recharge the tag's battery whenever the host device is plugged into an electrical outlet, essentially removing the need to replace or recharge the battery. The pass-through tag can also monitor the current consumption of the host device to measure its power consumption.

### SUMMARY OF THE INVENTION

In one form, the present disclosure describes a pass-through tag that provides electrical power to a host device. The pass-through tag uses a test signal to detect whether the pass-through tag has been disconnected from the host device and/or the power supply. If the connection between the pass-through tag and the host device and/or power supply has been tampered with, the pass-through tag transmits an alarm signal.

### BRIEF DESCRIPTION OF THE DRAWINGS

The foregoing and other features of the present disclosure will become apparent to those skilled in the art to which the present disclosure relates upon reading the following description with reference to the accompanying drawings.

FIG. 1 is a block diagram showing a system that can employ a pass-through tag between an electrical power source and an electrically powered host device (e.g., a medical equipment asset) in accordance with an example.

FIG. 2 is a schematic diagram of a pass-through tag that has a 3-wire alternating current (AC) pass-through connection and a cable connector (e.g., that can be utilized instead of a rigid connector) to interface with a host device in accordance with an example.

FIG. 3 is a network diagram showing components of a system of pass-through tags that can be used to monitor host devices for tampering in accordance with an example.

FIG. 4 is a block diagram of dedicated conductor lines embedded in the cord of the pass-through tag in accordance with an example.

FIG. 5 is a diagram of a power connector with a sensor to detect whether the connector is coupled to the host device in accordance with an example.

FIG. 6 is a flow chart showing how the pass-through tag detects whether the host device remains coupled to the pass-through tag in accordance with an example.

### DETAILED DESCRIPTION OF THE INVENTION

The present disclosure relates generally to an active radio frequency identification (RFID) device and, more specifically, to an active RFID device that supports an electrical pass-through connection between an associated host device and an electrical power source, and associated methods of use. In some instances, the pass-through connection may be used to monitor the host devices for tampering and/or current use. Additionally, the pass-through connection may be used to charge a battery of the RFID device. While the description below describes operation in a medical environment (e.g., a hospital), other facilities (e.g., factories, office buildings) may benefit from the system described herein to improve inventory control and utilization.

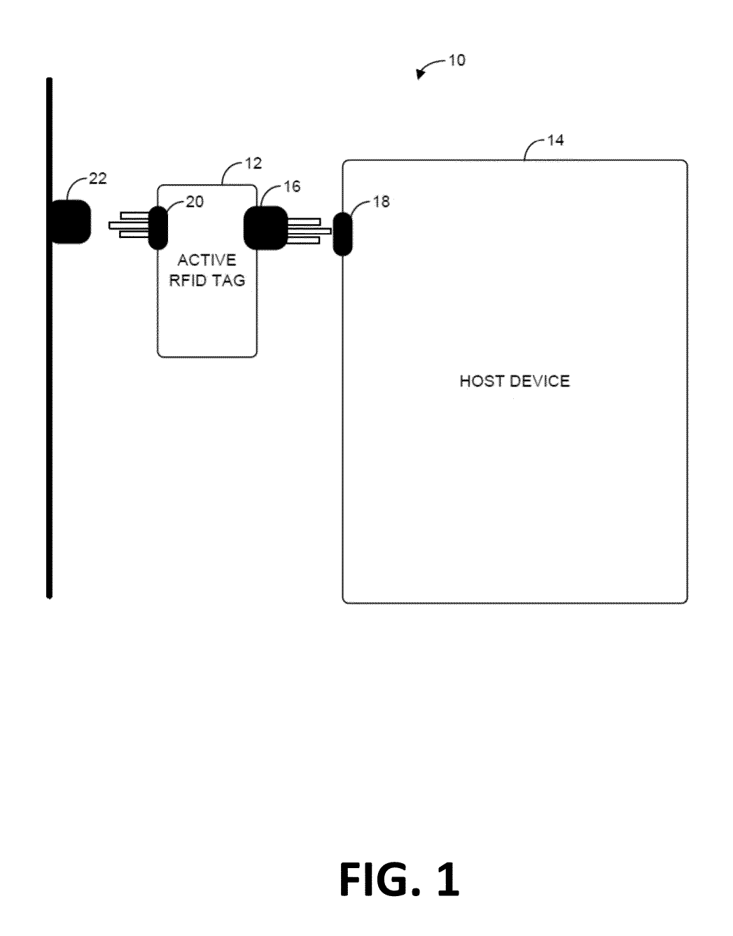

Active RFID tags are self-powered (e.g., via an internal battery) tags that can be attached to a host device such as an infusion pump, ventilator or hospital bed and transmit or receive wireless location beacon signals that can be used to determine the location of the tag. FIG. 1 illustrates an example of a system 10 employing an active RFID tag 12 that has an electrical pass-through connection between an external power source 22 and a host device 14. The external power source 22 is typically an AC power mains. The active RFID device 12, also referred to herein as a “pass-through tag”, can interface with the external power source 22 through an input power connector 20 and with the host device 14 through an output power connector 16, where both input and output power connectors are positioned on the exterior of the RFID device. The input and output connectors are electrically connected using a “pass-through” connection inside the device 12.

The pass-through tag 12 can, through its output power connector 16, interface with a power input port 18 (e.g., an IEC 60320 C14 AC power inlet, barrel DC connector, USB connector, or other power input port) of the host device 14. Although the output power connector 16 is illustrated in FIG. 1 as a male connecter and the power input port 18 is illustrated as a female connecter, it will be appreciated that other types of connections and/or interfaces can exist between the output power connector 16 and the power input port 18. For example, the male and female components can be reversed (e.g., the power input port 18 can include a plug that can interface with the output power connector 16). In another example, a different type of output power connector 16 can be used that corresponds to the configuration of the power input port 18 (e.g., a USB connection and a USB port, a serial connection and a serial port, etc.).

The pass-through tag 12 can also, through its input power connector 20, interface with an external power source 22. The external power source 22 may be an AC power mains, line power source, an emergency generator, DC power supply or other power source external to the pass-through tag 12. Although the input power connector 20 is illustrated as a male connector and the external power source 22 is illustrated as a female connector, it will be appreciated that other types of connections and/or interfaces can exist between the input power connector 20 and the external power source 22. For example, the male and female components can be reversed (e.g., the external power source 22 can include a plug that can interface with the input power connector 20).

Thus, as depicted in FIG. 1, the output power connector 16 can supply an output electrical power signal based on the input electrical signal received by the input power connector 20. The input electrical power signal may include an alternating-current signal. In another form, the input electrical power signal may include a direct-current signal and the output electrical power signal may comprise a direct-current signal.

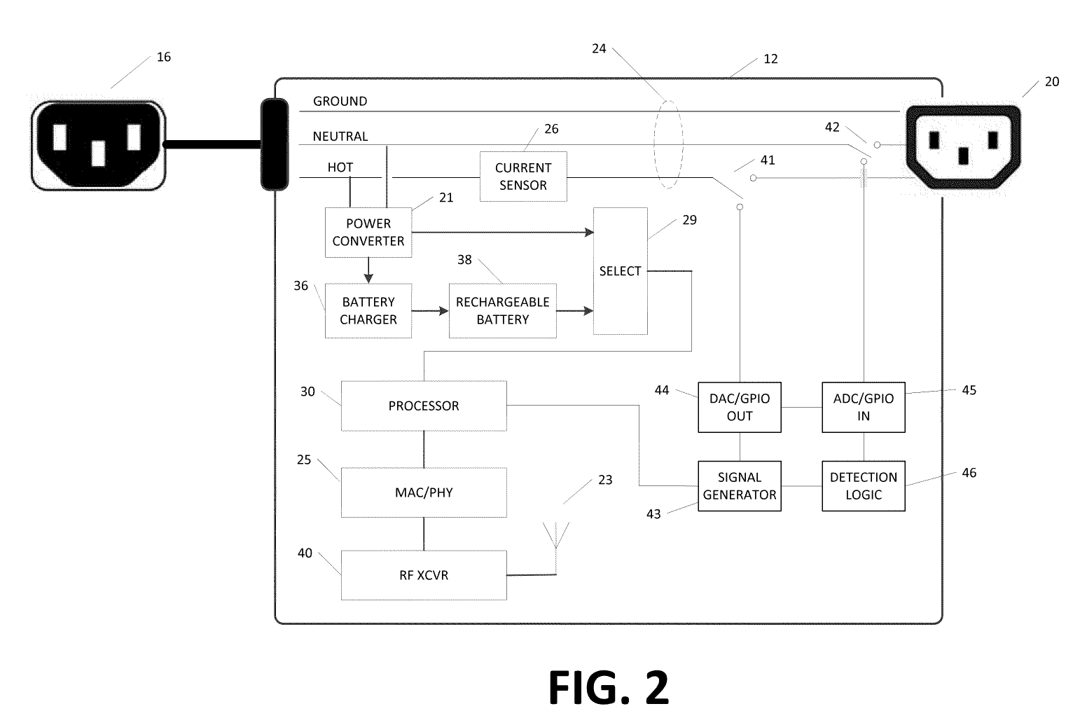

Referring to FIG. 2, the pass-through tag 12 may contain a wireless access control/physical layer (MAC/PHY) processor 25 and a RF transceiver 40. The RF transceiver can send and receive RF signals through an antenna 23 than may be positioned inside or outside the tag 12. The MAC/PHY processor 25 and RF transceiver 40 may be used to exchange current usage measurements with one or more remote servers. The MAC/PHY processor 25 and RF transceiver 40 may operate in accordance with a wireless standard such as IEEE 802.11/Wi-Fi®, Bluetooth®, Bluetooth Low Energy, or IEEE 802.15.4 Zigbee to communicate with the remote server through wireless access points. Alternatively, the pass-through tag 12 may communicate through wired communication means, such as power line communication through the AC mains power connector 20.

Additionally, the pass-through tag 12 may include a processor 30 with an associated memory for storing executable instructions and data. It is to be understood that the memory may be present in the various examples of the tag 12 presented herein, but for simplicity, it is not explicitly shown in the figures. The processor 30 is configured to execute the executable instructions to, among other things, detect whether a host device 14 remains attached to the tag 12. The processor 30 may encode an alarm signal into a data packet for transmission by the wireless transceiver 40.

The memory associated with the processor 30 can include read only memory (ROM), random access memory (RAM), magnetic disk storage media devices, optical storage media devices, flash memory devices, electrical, optical, and/or other physical/tangible/non-transitory memory storage devices. Thus, in general, the memory may comprise one or more tangible (non-transitory) computer readable storage media (e.g., a memory device) encoded with software comprising computer executable instructions and when the software is executed (e.g., by the processor 30) it is operable to perform various operations described herein.

The tag 12 may further contain a battery charger 36 that charges a rechargeable battery 38 whenever the host device is plugged into an AC mains, and a current sensor 26 that monitors the electrical current flowing from the power source 22 to the host device 14. A power converter 21 converts electrical power from the AC mains through power connector 20 to power the battery charger 36 and/or the remainder of the tag 12 through the power selection logic 29. The power selection logic 29 may select the power source of the tag 12 based on the state of the rechargeable battery 38 and whether the power converter 21 can supply the electrical power from the AC mains.

The tag 12 may additionally contain switches 41 and 42 in the hot and neutral conductors, respectively, typically used to pass electrical power from the AC mains to the host device 14. If the processor 30 detects that no current is being passed to the host device 14, e.g., through current sensor 26, then the tag 12 is assumed to be disconnected from the AC mains, and may enter a tamper alarm condition. A tamper alarm signal may or may not be sent via RF transceiver 40 when the tag 12 is detected to be removed from the AC power supply.

When it is determined that the tag 12 is unplugged form the AC mains, the processor 30 may periodically (e.g., every 5 minutes) run a loopback test procedure to determine if the host device 14 remains connected to the tag 12. In one example of the loopback test procedure, the switches 41 and 42 are moved to the “down” position. The processor 30 generates the test signal through signal generator logic 43 and applies the test signal through output logic 44, which may comprise a digital-to-analog converter (DAC) or general purpose input/output (GPIO) output. If the host device 14 remains attached to the tag 12, then a response signal will return through the neutral conductor and switch 42 will direct the response signal through input logic 45 (e.g., an analog-to-digital converter (ADC) or GPIO input) to detection logic 46. The detection logic 46 will notify the processor 30 whether a response signal was detected, and if no response signal was detected a tamper alarm signal may be transmitted through the RF transceiver 40. If the response signal is detected by the detection logic 46, then the processor may remove the tamper alarm condition. Switches 41 and 42 may be moved back to the “up” position after each iteration of the loopback test to enable the tag 12 to detect if the AC power is restored.

The loopback test procedure will work for most AC-powered medical devices because in most cases, the host device 14 will look like a large DC resistor (e.g., 1 megaohm) looking in from its power input terminals when the host device is not plugged into AC power. The input resistance of a typical input GPIO is significantly larger (e.g., 10 megaohm), making the neutral terminal voltage very close to the hot terminal voltage. For host devices 14 for which the loopback test procedure through the power conductors will not work (e.g., the impedance of the input power terminals is too high), an indication may be stored in an external database, and a different tamper detection scheme may be used.

In one example, the loopback test may be a DC signal (e.g., 3.3 V DC), an AC signal (e.g., a 20 Hz sinusoid), or an analog representation of a digital on/off signal (e.g., +3.3 VDC, −3.3 VDC, +3.3 VDC, etc.).

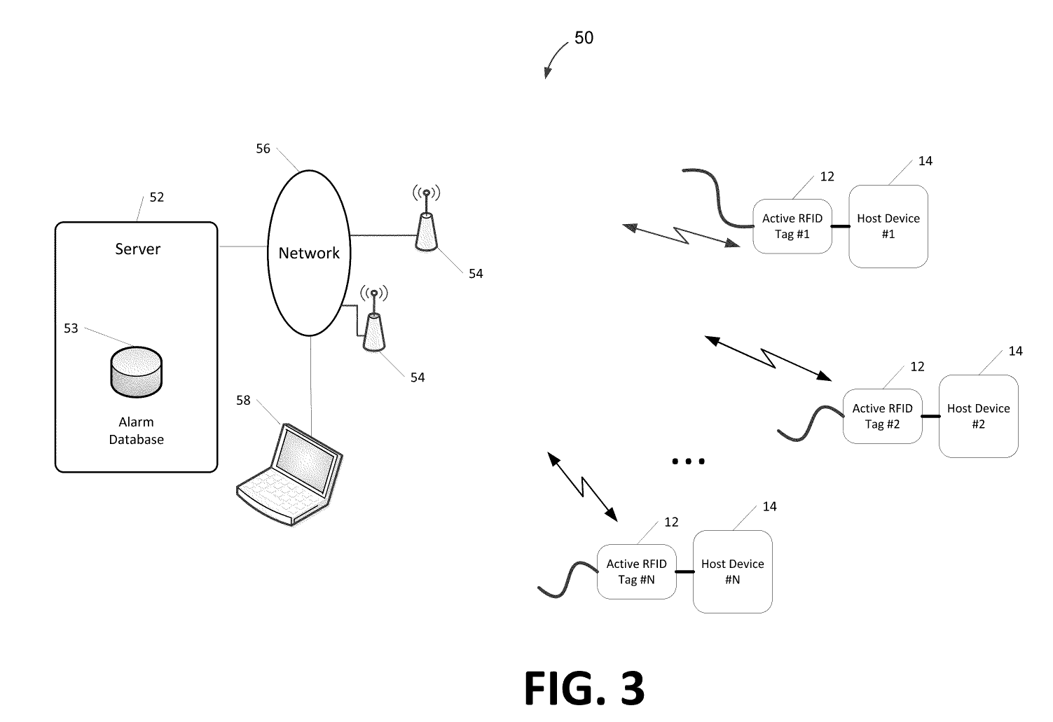

FIG. 3 illustrates an example of a system 50 employing one or more pass-through tags 12 communicating with a server 52 via a wireless network connection. Each tag is attached via an AC power cable to host device 14. Server 52 may be responsible for configuring the tags 12 and storing in a database the type, make, model number and serial number (e.g., a unique identifier) of the host devices to which they are attached. Server 52 may also store various alarm conditions in an alarm database 53. The alarm database 53 may record a log of which host devices and tags have sent alarm signals indicating that the tag has been disconnected from its respective host device, or that the tag has been disconnected from AC power.

In one example, the tags 12 communicate with Server 52 through one or more wireless Access Points (APs) 54 using a wireless internet signaling protocol such as IEEE 802.11 Wi-Fi. The Server 52 and wireless APs 54 may be coupled through network infrastructure 56 that also connects to one or more other user devices 58. The access points 54, tags 12 and host devices 14 that communicate with Server 52 may reside in different hospitals, buildings, and/or networks.

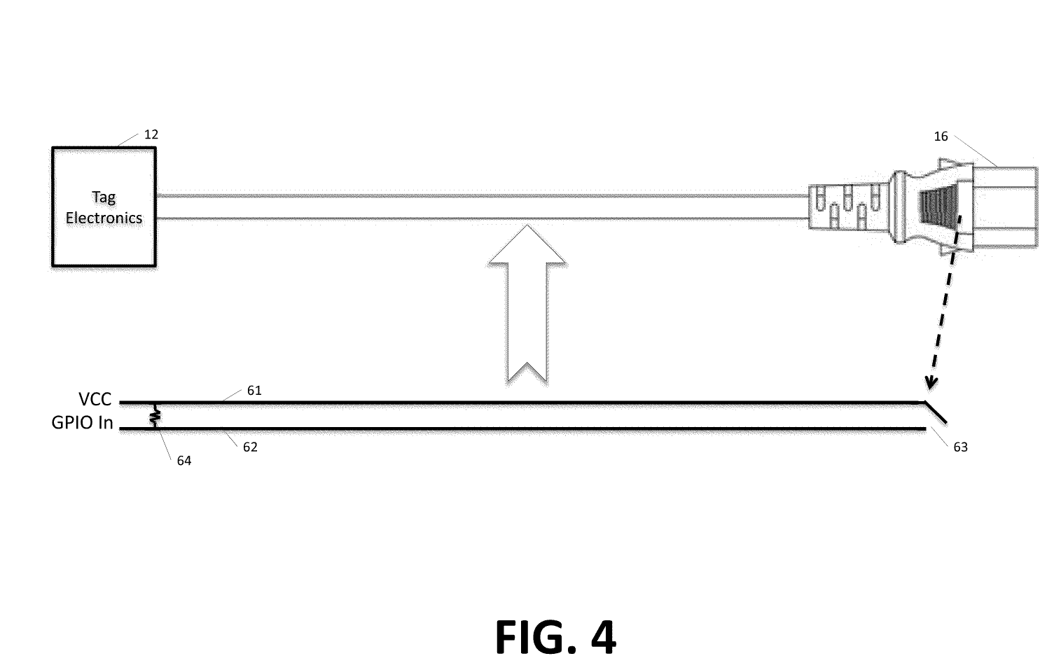

Referring now to FIG. 4, an example of a cord to couple the tag 12 to the host device 14 is shown. The tag 12 is connected to the power connector 16 by a cord that includes two dedicated connectors 61 and 62 along the length of the cord. The two dedicated wires run alongside the 3 conductors that carry AC power to the host device 14, and are connected to a switch 63 at the power connector 16. A pull-down resistor 64 may be included within the tag electronics.

In one example, the dedicated conductors 61 and 62 form a loop that is closed by switch 63 when the power connector 16 is plugged in to a host device 14. The switch 63 may be controlled by any mechanism that detects whether the power connector 16 is engaged with a host device 14, e.g., a plunger, locking tabs, an optical switch, or a magnetic switch. The tag electronics may also detect if the cord is physically cut, since cutting the cord would sever the switch 63 from the circuit in the dedicated conductors. The tag electronics would detect the open circuit, and may transmit an alarm signal to indicate that the host device 14 is no longer connected to the tag 12.

In another example, multiple sets of dedicated conductors may be embedded alongside the AC power conductors. Each set of dedicated conductors may have a different switch 63 terminating the conductors, such that the sets detect various criteria for determining whether the connector 16 is connected to the host device 14. For example, one set of conductors may be permanently closed, such that physically severing the cord would be detected. Another set of conductors may be terminated by a plunger in the end of the connector 16. A third set of conductors may be terminated by locking tabs in the connector 16. Each set of dedicated conductors may determine a distinct condition that the tag electronics may analyze to determine whether to signal an alarm condition.

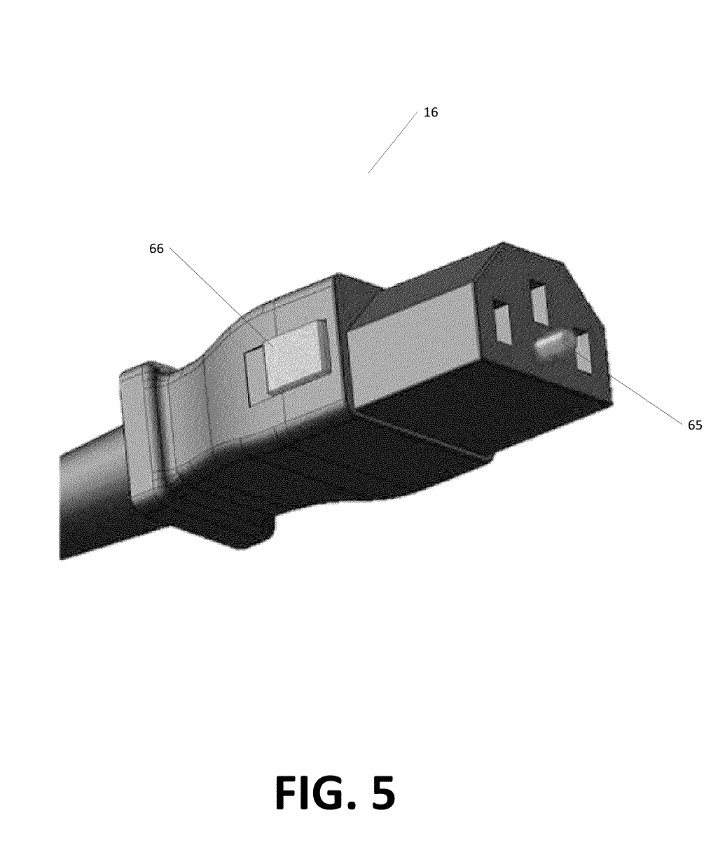

Referring now to FIG. 5, a magnified view of an example of power connector 16 is shown. The power connector 16 includes a plunger 65 that is depressed when the connector 16 is plugged into the appropriate socket. Additionally, the power connector 16 may include locking tabs 66 that secure the connector 16 in the appropriate socket to prevent inadvertent removal of the connector 16. One or both of the plunger 65 or locking tabs 66 may be configured to function as switch 63 on the same or different sets of dedicated conductors embedded alongside the AC power conductors.

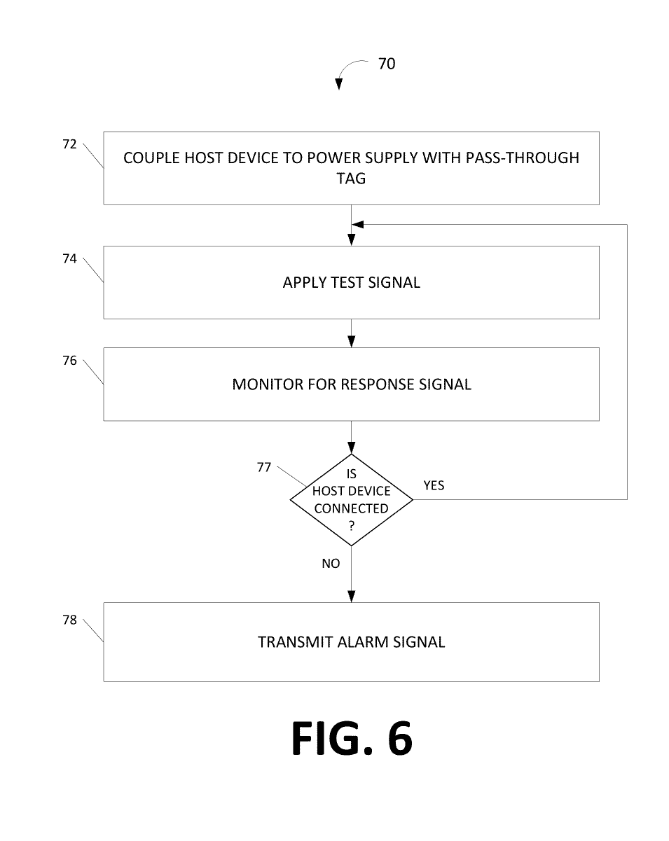

Referring now to FIG. 6, a procedure 70 of determining whether the host device is coupled to a pass-through tag is shown. In step 72, the host device is coupled to a power supply, such as an AC mains, with a pass-through tag. The pass-through tag applies a test signal in step 74, and listens for a response signal in step 76. If the host device is no longer connected to the pass-through tag, as determined in step 77, then the pass-through tag transmits an alarm signal in step 78. If the host device remains connected to the pass-through tag, then the pass-through tag may periodically repeat the test signal to detect whether the host device remains coupled to the pass-through tag.

In one example, the test signal is applied to the hot conductor of the pass-through tag and the neutral conductor is monitored for the response signal. If no response signal is detected after a predetermined amount of time, then the host device may be determined to be disconnected from the pass-through tag, triggering the alarm signal.

In another example, the test signal may be applied in response to detecting a specific event, such as an accelerometer suggesting that the pass-through tag was removed with force from the host device. Other events triggering the application of the test signal may include the loss of an AC voltage from the power supply or the current passing through the tag falling below a predetermined level.

In summary, the techniques presented herein provide for a pass-through tag that detects whether it remains attached to a host device and/or the power supply for the host device. The pass-through tag sends a test signal toward the host device and monitors for a response signal indicating that the pass-through tag is coupled to the host device. The test signal may be applied along the power conductors or along isolated conductors dedicated to the tamper detection system. If the response signal, or the lack of a response signal after a pre-determined amount of time, indicates that the pass-through tag has been unplugged from the host device, then the pass-through tag can alert a central server through an RF transceiver in the tag.

From the above description, those skilled in the art will perceive improvements, changes and modifications. Such improvements, changes and modifications are within the skill of one in the art and are intended to be covered by the appended claims.

What is claimed is:

1. A method comprising:
electrically connecting a pass-through tag to a host device;
applying a test signal along a connection between the pass-through tag and the host device;
monitoring for a response signal corresponding to the test signal to determine whether the pass-through tag is electrically connected to the host device;
responsive to a determination that the pass-through tag is not electrically connected to the host device, transmitting a tamper alarm signal.

2. The method of claim 1, wherein applying the test signal comprises applying the test signal to one or more conductors in the pass-through tag that are configured to supply power to the host device.

3. The method of claim 2, wherein applying the test signal comprises applying the test signal to a hot conductor of the conductors that are configured to supply power, and wherein detecting the response signal comprises monitoring a neutral conductor for the response signal.

4. The method of claim 1, wherein the test signal comprises one or more of a direct current signal, an alternating current signal, or an analog representation of a digital signal.

5. The method of claim 1, wherein the test signal is repeated periodically.

6. The method of claim 1, wherein the test signal is applied in response to detecting one or more triggering events.

7. The method of claim 6, wherein the one or more triggering events comprise detecting that the pass-through tag is no longer coupled to a power supply.

8. The method of claim 6, wherein the one or more triggering events are detected by a sensor in the pass-through tag.

9. The method of claim 8, wherein the sensor comprises an accelerometer, a physical switch, a magnetic switch, an optical switch, a voltage sensor, or a current sensor.

10. The method of claim 1, wherein the test signal is applied to dedicated conductors that are not electrically connected to the host device.

11. A pass-through tag comprising:
a first power connector configured to couple to a host device;
a second power connector configured to couple to a power supply;
a plurality of electrical power conductors configured to electrically couple the host device to the power supply; and
a processor configured to:
apply a test signal to the first power connector;
detect a response signal corresponding to the test signal to determine whether the pass-through tag is coupled to the host device via the first power connector; and
responsive to a determination that the pass-through tag is not coupled to the host device via the first power connector, transmitting a tamper alarm signal.

12. The pass-through tag of claim 11, wherein the processor is configured to apply the test signal to one or more of the plurality of electrical power conductors.

13. The pass-through tag of claim 12, wherein the processor is configured to:
apply the test signal to a hot conductor of the electrical power conductors; and
detect the response signal by monitoring a neutral conductor of the electrical power conductors for the response signal.

14. The pass-through tag of claim 11, wherein the processor is configured to periodically repeat the applying of the test signal.

15. The pass-through tag of claim 11, wherein the processor is configured to apply the test signal in response to detecting one or more triggering events.

16. The pass-through tag of claim 15, wherein the processor is configured to detect the one or more triggering events by detecting that the second power connector is no longer coupled to the power supply.

17. The pass-through tag of claim 16, further comprising a battery to power the test signal when the second power connector is no longer coupled to the power supply.

18. The pass-through tag of claim 15, further comprising a sensor configured to detect the one or more triggering events.

19. The pass-through tag of claim 17, wherein the sensor comprises an accelerometer, a physical switch, a magnetic switch, an optical switch, a voltage sensor, or a current sensor.

20. The pass-through tag of claim 11, further comprising a plurality of dedicated conductors that are not electrically connected to the plurality of electrical power conductors, and wherein the processor is configured to apply the test signal to the dedicated conductors.
